(19) United States
(12) Patent Application Publication
(10) Pub. No.: US 2020/0035127 A1
(43) Pub. Date: Jan. 30, 2020

(54) PORTABLE SURGERY SIMULATION SYSTEM AND METHODS OF MAKING AND USING THE SAME

(71) Applicant: Timothy S. Sullivan, Chapel Hill, NC (US)

(72) Inventor: Timothy S. Sullivan, Chapel Hill, NC (US)

(21) Appl. No.: 16/048,528

(22) Filed: Jul. 30, 2018

(51) Int. Cl. G09B 23/28

(52) U.S. Cl. CPC G09B 23/28

(57) ABSTRACT

The presently disclosed subject matter is directed to a portable surgical simulation system. Particularly, the simulation system comprises a cover that includes one or more ports that allow a user to access a tissue sample housed within the cover interior. The system further comprises a base that houses the mechanical elements of the simulator (e.g., fluid pump, tubing, pressure control valves, pressure gauge, and the like). The base further includes a working surface that provides a support upon which the tissue sample rests during the surgical simulation. The disclosed system therefore allows a user to simulate surgical techniques using live tissue for educational and training purposes.

### TECHNICAL FIELD

The presently disclosed subject matter relates to a portable surgery simulation system and to methods of making and using the disclosed system.

### BACKGROUND

Medical students and doctors learning new surgical techniques must undergo extensive training before they are qualified to perform surgery on human patients. While teaching aids are available for one or more aspects of surgical training, they suffer from many drawbacks. For example, live animal model labs can be used, but they are costly, cumbersome, ethically challenging, highly regulated, and very time and location sensitive. Further, prior art tissue simulators are not designed to be lightweight and/or ultra-portable and don't offer user and bystander protection from potentially hazardous exposure. Current tissue simulators are also too complex and cost prohibitive for consistent use. It would therefore be desirable to provide a self-contained and portable surgical “bleeding” tissue lab that overcomes the shortcomings of the prior art.

### SUMMARY

In some embodiments, the presently disclosed subject matter is directed to a surgical simulation system. The system comprises a base comprising an interior; a fluid basin configured for housing a volume of fluid, positioned within the interior of the base; a fluid pump positioned within the interior of the base, wherein a tubing connects the fluid basin to an inlet of the fluid pump; an input pressure control valve connected via tubing to an outlet of the fluid control pump; an optional pressure gauge connected via tubing to an outlet of the input pressure control valve; tubing configured to connect the input pressure control valve to an input on a tissue sample; tubing configured to connect an output on a tissue sample to a return pressure control valve; tubing that connects the return pressure control valve to the fluid basin; a cover comprising a plurality of sidewalls and an open bottom that rests on the base to create an enclosed space, wherein at least one sidewall comprises an access port that spans the sidewall; and a working surface for supporting a tissue sample, wherein the working surface is positioned within the interior of the base, adjacent to the cover.

In some embodiments, the cover is at least partially constructed from one or more transparent materials. In some embodiments, the cover comprises a light source, camera, or both.

In some embodiments, the base has a bottom surface comprising a plurality of wheels, collapsible legs, or both.

In some embodiments, the working surface is configured at an angle within the interior of the base. In some embodiments, the angle is about 1-10 degrees.

In some embodiments, a covering is positioned over the working surface, adjacent to the cover. In some embodiments, the covering includes a central depression sized and shaped to allow a tissue sample to rest thereon. In some embodiments, the covering comprises one or more apertures sized and shaped to allow tubing to pass therethrough.

In some embodiments, the input pressure control device, return pressure control device, or both comprise a solenoid valve.

In some embodiments, the base comprises one or more compartments housed within the interior, configured for containing cleaning supplies, surgical tools, used tissue samples, and combinations thereof.

In some embodiments, the system further comprises a heating element, cooling element or both, configured to heat or cool the fluid as it is pumped through the system.

In some embodiments, the presently disclosed subject matter is directed to a method of performing a surgery simulation on a tissue sample. The method comprises depositing the tissue sample on the working surface of a surgery simulation system, the simulation system comprising a base comprising an interior; a fluid basin configured for housing a volume of fluid, positioned within the interior of the base; a fluid pump positioned within the interior of the base, wherein a tubing connects the fluid basin to an inlet of the fluid pump; an input pressure control valve connected via tubing to an outlet of the fluid control pump; an optional pressure gauge connected via tubing to an outlet of the input pressure control valve; tubing configured to connect the input pressure control valve to an input on a tissue sample; tubing configured to connect an output on a tissue sample to a return pressure control valve; tubing that connects the return pressure control valve to the fluid basin; a cover comprising a plurality of sidewalls and an open bottom that rests on the base to create an enclosed space, wherein at least one sidewall comprises an access port that spans the sidewall; and a working surface for supporting a tissue sample, wherein the working surface is positioned within the interior of the base, adjacent to the cover. The method further comprises depositing a volume of fluid in the fluid basin; initiating the pump to begin pumping the fluid from the fluid basin, through the pump, through the input pressure control valve, through the optional pressure gauge, through the tissue sample, through the return pressure control valve, and back to the fluid basin; and performing the surgery simulation by accessing the tissue sample through the access ports of the cover.

In some embodiments, the system further comprises a heating element, cooling element, or both, such that fluid passes through the elements to be heated or cooled as desired by the user.

In some embodiments, the cover is at least partially constructed from one or more transparent materials.

In some embodiments, the base has a bottom surface comprising a plurality of wheels, collapsible legs, or both.

In some embodiments, the working surface is configured at an angle within the interior of the base.

In some embodiments, a covering is positioned over the working surface, adjacent to the cover. In some embodiments, the covering includes a central depression sized and shaped to allow a tissue sample to rest thereon. In some embodiments, the covering comprises one or more apertures sized and shaped to allow tubing to pass therethrough.

### BRIEF DESCRIPTION OF THE DRAWINGS

The previous summary and the following detailed descriptions are to be read in view of the drawings, which illustrate some (but not all) embodiments of the presently disclosed subject matter.

FIG. 1 is a perspective view of a simulator system in accordance with some embodiments of the presently disclosed subject matter.

FIG. 2a is a perspective view of a cover that can be used with a simulator system in accordance with some embodiments of the presently disclosed subject matter.

FIG. 2b is a front plan view of an access port configured on a cover of a simulator system in accordance with some embodiments of the presently disclosed subject matter.

FIG. 2c is a bottom plan view of a simulator cover comprising a camera and light source in accordance with some embodiments of the presently disclosed subject matter.

FIG. 3a is a perspective view of a simulator system base in accordance with some embodiments of the presently disclosed subject matter.

FIG. 3b is a perspective view of the base of FIG. 3a in an open configuration.

FIG. 3c is a perspective view of the base of FIG. 3a comprising handles, wheels, and retractable legs in accordance with some embodiments of the presently disclosed subject matter.

FIG. 3d is a perspective view of a base comprising legs in accordance with some embodiments of the presently disclosed subject matter.

FIG. 4a is a perspective view of a base comprising a working surface in accordance with some embodiments of the presently disclosed subject matter.

FIG. 4b is a top plan view of a base comprising a working surface in accordance with some embodiments of the presently disclosed subject matter.

FIGS. 5a and 5b are perspective views of a base comprising a tissue bed in accordance with some embodiments of the presently disclosed subject matter.

FIG. 6a is a perspective view of a fluid basin in accordance with some embodiments of the presently disclosed subject matter.

FIG. 6b is a perspective view of the fluid basin of FIG. 6a comprising a lid.

FIG. 7a is a perspective view illustrating a base comprising a fluid basin, a pump, and associated tubing in accordance with some embodiments of the presently disclosed subject matter.

FIG. 7b is a perspective view of the base of FIG. 7a, further comprising an inlet pressure control valve in accordance with some embodiments of the presently disclosed subject matter.

FIG. 7c is a perspective view of the base of FIG. 7b, further comprising a pressure gauge in accordance with some embodiments of the presently disclosed subject matter.

FIG. 7d is a perspective view of a base comprising a working surface, a tissue bed, a tissue sample, and associated tubing in accordance with some embodiments of the presently disclosed subject matter.

FIGS. 7e and 7f are fragmentary side plan views of the disclosed base comprising a tissue sample in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed system and methods.

The presently disclosed subject matter is directed to a portable surgical simulation system. Particularly, as shown in FIG. 1, system 5 comprises cover 10 that includes one or more ports 15 that allow a user to access a tissue sample housed within cover interior 20. The system further comprises base 25 that houses the mechanical elements of the simulator (e.g., fluid pump, tubing, pressure control valves, pressure gauge, and the like). The base further includes working surface 30 that provides a support upon which the tissue sample rests during the surgical simulation. As set forth in detail herein below, the disclosed system allows a user to simulate surgical techniques using live tissue for educational and training purposes.

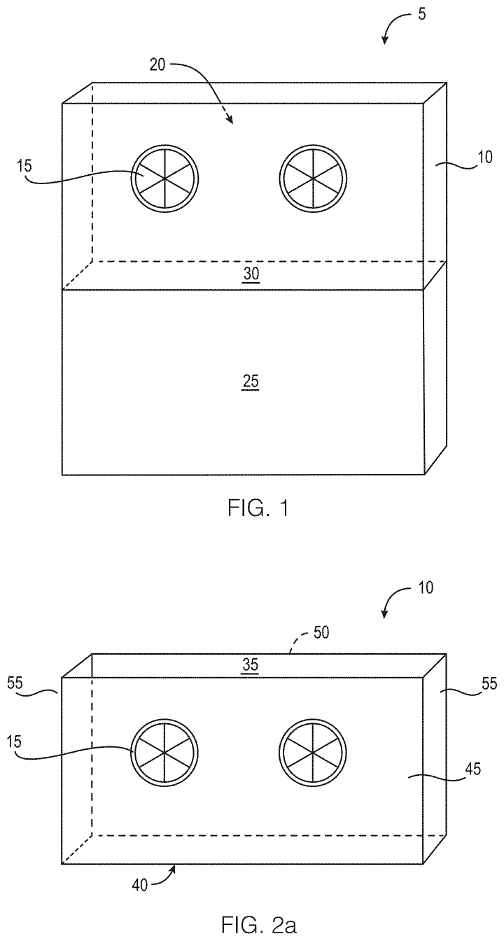

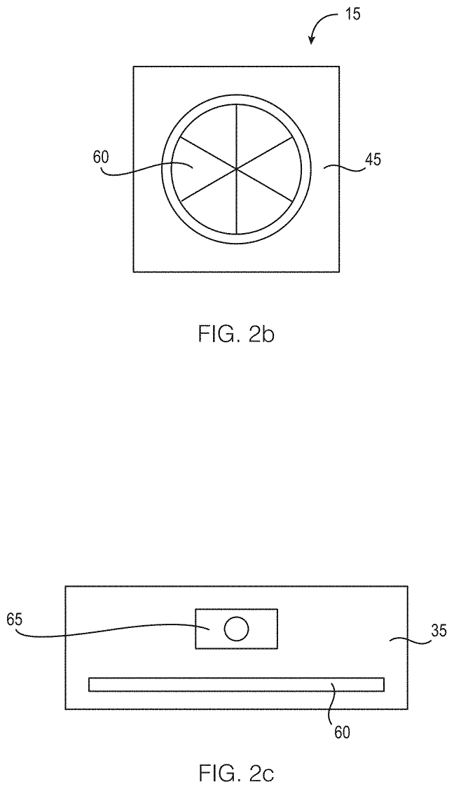

FIG. 2a illustrates one embodiment of cover 10 that is used to provide a sealed environment for conducting the surgical simulation. The cover includes top face 35, open bottom 40, front face 45 and opposed rear face 50, and side faces 55 that define interior 20. In some embodiments, the base includes a frame to provide support for the cover. The frame can be constructed from any desired rigid and/or supportive material, such as metal (e.g., aluminum, stainless steel), plastic, wood, and combinations thereof. The cover advantageously protects the user and bystanders from direct and indirect contact with tissue and/or fluid exposure. In some embodiments, the cover is constructed from a lightweight material to allow the user to easily install, replace, or discard a sample by removing and replacing the cover.

As shown, cover 10 can be configured in a generally rectangular or square shape. However, the shape of the cover is not limited, and be constructed in any desired shape.

In some embodiments, the cover can be configured such that the various faces are capable of nesting for storage and/or shipping. For example, in some embodiments, front, rear, side, and top faces can separate to be individually stored, and then easily be re-assembled for use. Further, the cover can optionally be nested to provide compact single-container protected storage and shipping. For example, the cover can be nested within the base. Alternatively, the individual faces of the cover can be separated and stored within the base.

Cover 10 can be constructed from any desired material, including (but not limited to) glass, polymeric materials, or combinations thereof. It should be appreciated that at least one of the top, front, rear, and side faces are transparent to allow the user and/or observers to see within the cover interior. The term “transparent” refers to the ability to transmit light without appreciable scattering so that objects beyond (e.g., a tissue sample) are entirely visible. Thus, at least one face (or all faces) of the cover has a total transmittance of at least about 60%, 70%, 80%, 90% (according to ASTM D 1003-07, incorporated by reference herein).

The cover further includes one or more access ports 15 that enable items (e.g., surgical instruments, the user's hands) to be inserted into interior 20 to access the tissue sample. FIG. 2b illustrates one embodiment of access port 15 that extends through a face of cover 10. As shown, the port can include a self-closing opening formed by intersecting slits 60 formed from a pliable material (e.g., rubber, plastic). When desired, the user can provide pressure to the slits to create an opening to access the interior of the cover. The access ports are therefore closed at rest, and form around the user's hand (or surgical instrument) when passing through the opening. In this way, port 15 is splash-resistant.

One or more ports 15 can be disposed on any face of the cover. For example, in some embodiments, a pair of ports can be positioned on front face 45 and rear face 50. One skilled in the art will appreciate that the access port can be configured in a variety of shapes and sizes depending upon the type of surgical procedure simulated. By way of non-limiting example, as illustrated in FIG. 2b, port 15 can be configured with a substantially oval-shaped opening. Port 15 can be constructed in any desired size, so long as it allows a user's hands and/or a desired surgical instrument to pass therethrough.

In some embodiments, the cover can comprise a light source within interior 20. The light source can include any known illumination source, such as (but not limited to) fluorescent lights, incandescent lights, light-emitting diodes, lamps, lasers, and the like. The light source can be positioned to direct light toward the tissue sample to allow the user and/or an audience to view the surgical simulation. In some embodiments, the light source can be moved to selectively illuminate different portions of a sample. In some embodiments, the light source can be removable to allow the cover to be cleaned before and after a simulation. It should be appreciated that the system can include additional lighting configured outside the cover.

In some embodiments, cover 10 can comprise a camera to record and/or transmit a surgical simulation. Thus, a camera can be mounted within or adjacent to the cover interior to provide a suitable viewing angle. The camera can be removable to allow the cover to be cleaned before and after a simulation. FIG. 2c illustrates one embodiment of top face 35 of the cover comprising light source 60 and camera 65.

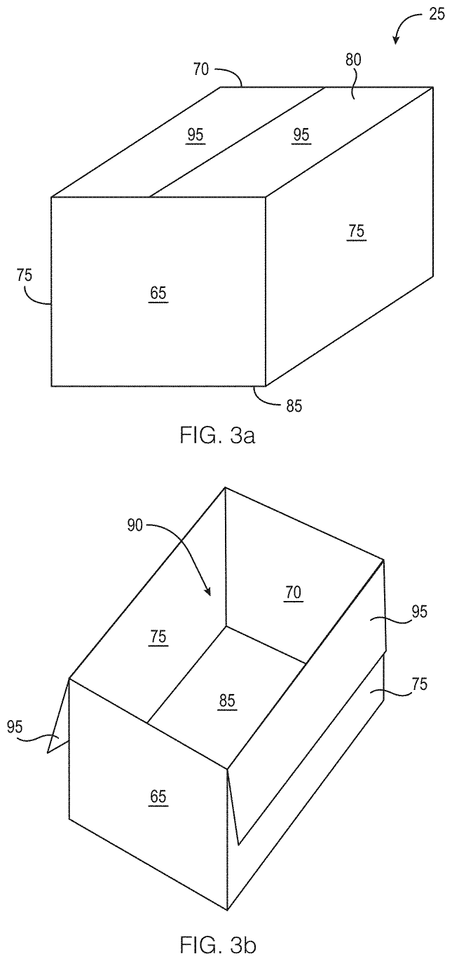

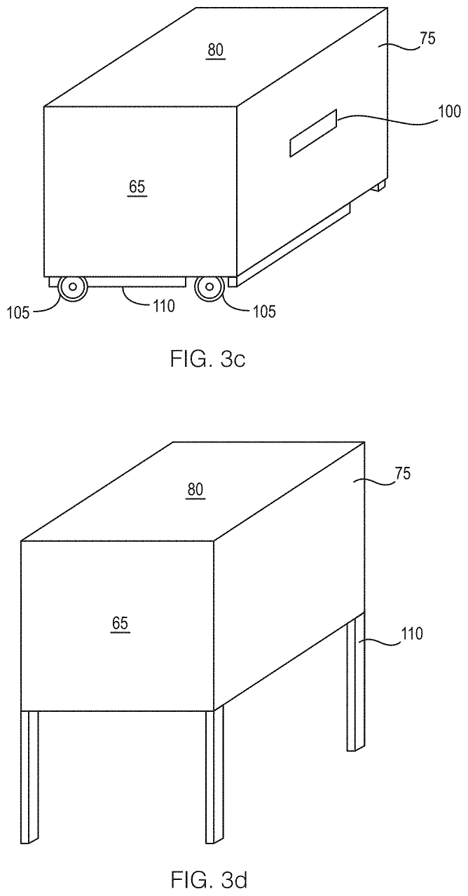

As set forth above, the system comprises base 25 that encloses the required mechanical elements (e.g., fluid pump, pressure control valves, fluid basin, pressure gauge). FIG. 3a illustrates one embodiment of base 25 in a closed (e.g., storage) configuration. As shown, the base comprises front face 65 and opposing rear face 70, opposing side faces 75, and opposing top and bottom faces 80, 85 that define interior 90. In some embodiments, the top face can be configured with panels 95 that separate to allow access to the interior of the base, as shown in FIG. 3b. However, base 25 is not limited, and access to the interior can be accomplished in any known way (e.g., by removing top face 80). The base thus is configured with a work-through top, allowing for the mechanics to be hidden and the user to work with a tissue sample while they are protected from the tissue or any fluid exposure.

As shown, base 25 can be configured in a generally rectangular or square shape. However, the shape of the base is not limited, and be constructed in any desired shape. It should be appreciated that the base can be configured with a similar shape and/or dimension as cover 10 to allow the open bottom face of the cover to rest on or within the interior of the base, as described in more detail below.

Base 25 can be constructed from any desired material, including (but not limited to) one or more rigid materials. The term “rigid” as used herein refers to a material that has a high stiffness or modulus of elasticity. In some embodiments, the rigid material has a modulus of elasticity of about 0.5×10⁶ psi or greater, determined in accordance with ASTM D-638 (incorporated by reference herein). Thus, a rigid material holds a shape without external support and has a high resistance to deformation by external forces. Suitable rigid materials can be selected from rigid polymers, metal, wood, and combinations thereof. In some embodiments, the materials used to construct base 25 are lightweight materials, such as (but not limited to) plastic, fiberglass, carbon fiber, or combinations thereof.

The base can comprise built-in draping and signage attachments. For example, one or more attachments can be releasably positioned to cover all or a portion of base 25. Suitable attachments can include draping to give an attractive visual appearance to the system (e.g., by covering at least a portion of the base). Suitable attachments can further include corporate, sponsorship, and/or promotional information, logos, and signage, as would be known in the art. The attachments can be releasably attached to the base using any known method, such as the use of magnets, hook-and-loop closures (VELCRO®), or mechanical elements (e.g., snaps, hooks, clips, locks).

In some embodiments, base 25 comprises one or more handles 100 as shown in FIG. 3c. The handles allow a user to easily move the simulator system to a desired location. Handle 100 is not limited and can include any prior art handle or gripping mechanism.

Optionally, base 25 can include a plurality of wheels designed to allow the user to position the system in any desired location. As illustrated in FIG. 3c, wheels 105 can be attached to bottom face 85 of the base and permit the base to be easily repositioned. In some embodiments, the wheels can be attached at the four corners of bottom face 85 using conventional methods.

Base 25 can include a plurality of collapsible legs 110 that can be used to elevate the simulator system to a desired height. For example, a plurality of collapsible legs can be pivotally mounted near the outer periphery of bottom face 85 of the base, as illustrated in FIGS. 3c and 3d. Particularly, FIG. 3c illustrates one embodiment of the base with legs in a folded, storage position. FIG. 3d depicts the base with legs 110 extended, such that the simulation system can be easily assembled and used at a convenient height for the user. The base can include any number of legs, such as 3, 4, 5, or more.

As shown in FIG. 3b, top face 80 of the base can be opened or removed to access interior 90. The interior can house each element of the disclosed system therein, such as during shipping and/or storage. Thus, the interior can be sized and shaped to house cover 10, working surface 30, tubing, and the like. Base interior 90 can further include one or more optional elements, such as surgical tools, electrical supply ports, cleaning supplies, disposal containers, etc. The base is therefore a self-contained and easily transportable unit.

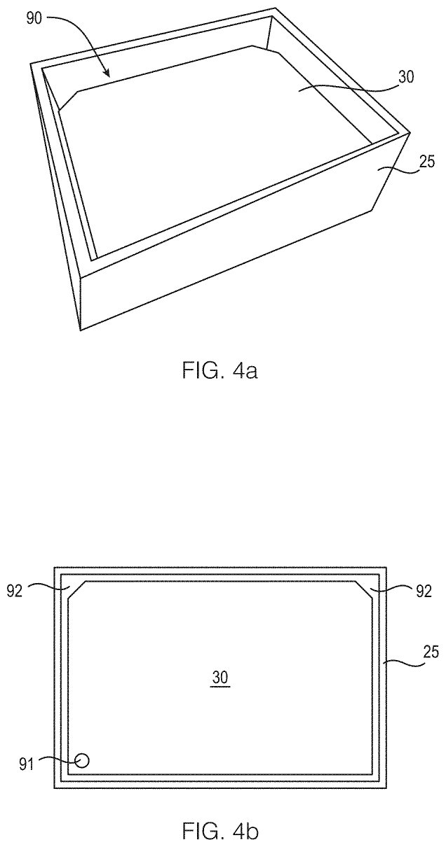

As described above, simulator system 5 includes working surface 30 that provides a support surface for the live tissue sample. As shown in FIG. 4a, the working surface is positioned horizontally within the interior of the top portion of the base (e.g., adjacent to cover 10 when the system is fully assembled). Particularly, interior 90 of base 25 can maintain the working surface using any known mechanism (e.g., risers, support lip, etc.). Accordingly, the working surface provides a stable surface within the interior of the base for the simulation. The working surface can be configured to be flush or about flush with the interior of the base. Further, the working surface includes opening 91 and/or passageway 92 that serve as an access to the mechanics housed below the working surface, as shown in FIG. 4b.

In some embodiments, working surface 30 can be configured to be sloped at one end to enable drainage of fluid during use. For example, the working surface can have any desired slope to effect movement of the fluid, such as about 1-10 degrees (e.g., 1, 2, 3, 4, 5, 6, 7, 8, 9, or 10 degrees). Thus, any fluid that contacts the working surface follows the slope and flows to a fluid basin positioned on the bottom of the base. The fluid is thus collected and pumped back through the tissue sample, as described in detail below. In some embodiments, the fluid flows through opening 91 and/or passageway 92.

Working surface 30 can be constructed from any rigid or semi-rigid material, such as metal, plastic, wood, and the like. In some embodiments, the material used for the working surface can be easily washed and/or sterilized between uses. It should be appreciated that the working surface further functions to hide the mechanical elements of the simulator from view (e.g., they are positioned within the base interior, below the working surface).

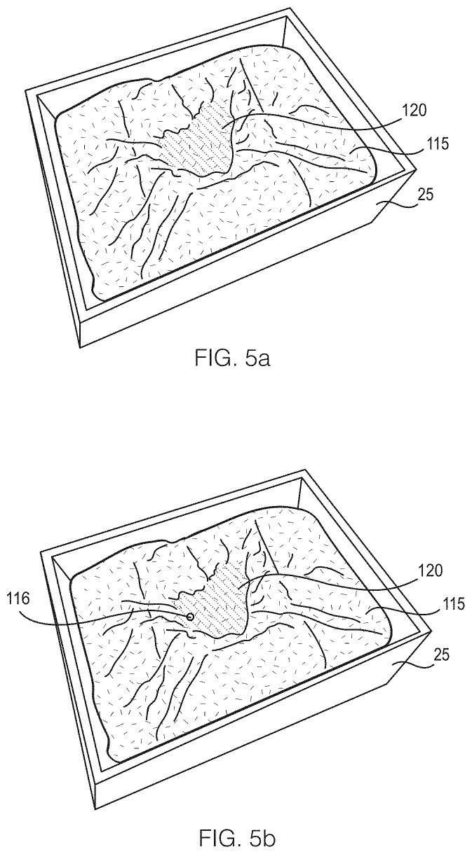

The system includes mock tissue bed 115 positioned on top of working surface 30, adjacent to the cover, as shown in FIG. 5a. The tissue bed is configured to make direct contact with a live tissue sample. The term “live tissue sample” refers to a sample in which most of the cells are viable (e.g., at least 50, 60, 70, 80, or 90 percent viable). The tissue bed can be configured with central depression 120 that is sized and shaped to house the tissue sample. In some embodiments, depression 120 can be customized for a desired surgical procedure (e.g., heart-shaped indentation, liver-shaped indentation, etc.). Further, depression 120 reduces the likelihood that the tissue sample changes position during the surgical simulation. In some embodiments, tissue bed 115 can be disposable and constructed from paper or other low-cost materials. Alternatively, the tissue bed can be constructed from silicone or similar materials that can be washed and reused for multiple simulations.

In some embodiments, the tissue bed includes one or more apertures 116, as illustrated in FIG. 5b. Apertures 116 allow at least a portion of the tubing that connects to the tissue sample to be hidden. In embodiments without aperture 116, the tubing can be extended from a side or corner of the working surface and tissue bed.

The simulation system includes a fluid basin positioned on the bottom of base 25 to house fluid that is pumped through the tissue sample. Any desired fluid can be used. For example, in some embodiments, the fluid can be blood (e.g., human blood, animal blood) or a blood-like fluid, such as a modified liquid costume or stage blood. It should be appreciated that any liquid of light (10,000 cps and below at 25° C.) to moderate viscosity (10,000-30,000 cps at 25° C.) can be used.

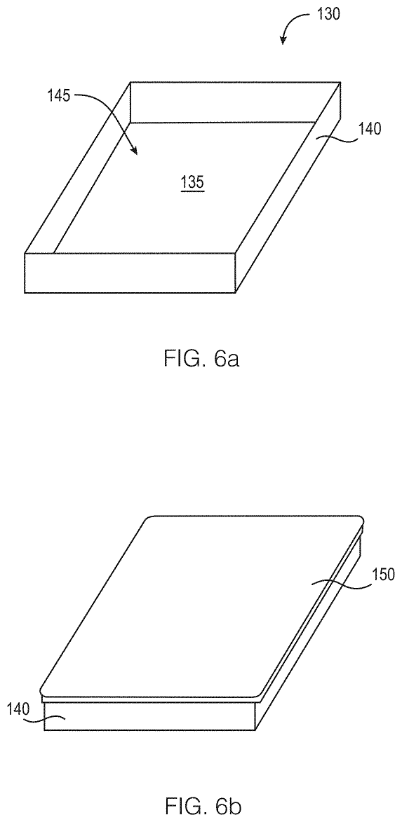

FIG. 6a illustrates one embodiment of fluid basin 130 configured as a tray, with bottom 135 and a plurality of sidewalls 140 that join together to form interior 145. In some embodiments, the fluid basin is rectangular in shape, although it can be constructed in any desired shape. Fluid basin 130 can be attached to bottom face 85 of the base using any desired mechanism, such as (but not limited to) screws, clamps, suction, hook-and-loop closures and the like. Alternatively, the fluid basin can simply rest on the bottom face of the base without any attachment element. The fluid basin can be removed from the base if desired, such as for cleaning. Alternatively, the fluid basin can be permanently attached to the base. As shown in FIG. 6b, in some embodiments the fluid basin can include lid 150 to prevent fluid spills, such as during travel.

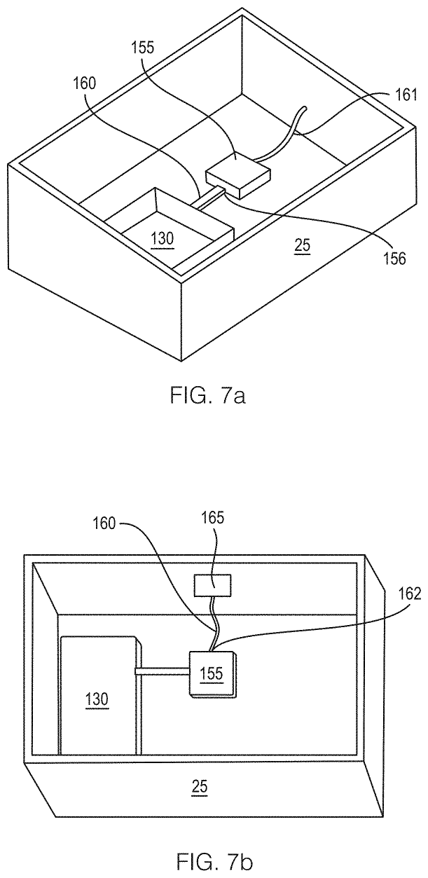

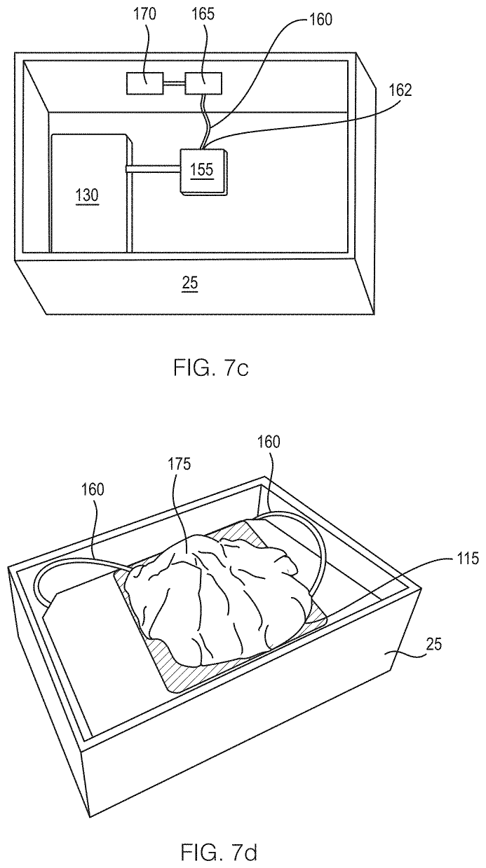

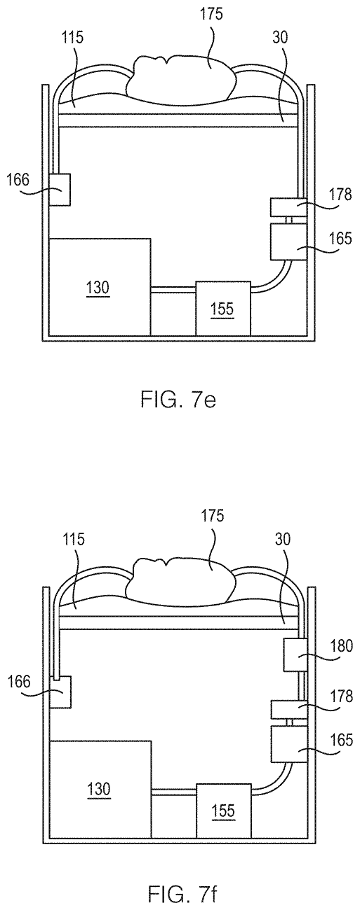

A pump is positioned on the bottom face of base 25 and is attached to the fluid basin for fluid intake via tubing 160, as shown in FIG. 7a. Particularly, pump 155 includes inlet 156 through which fluid is fed from the fluid basin via tubing 160. The tubing can be any standard tubing known or used in the art. Further, the tubing can have any desired diameter (e.g., 0.25 inches or less). The tubing is mounted to the pump inlet using any mechanism, e.g., a hose clamp. The pump can be attached to the bottom face of the base using any desired mechanism (e.g., clips, hooks, etc.) or can simply rest on the bottom surface. In some embodiments, power cord 161 runs from an electrical outlet and attaches to the pump to provide electricity during operation. Operation of the pump can therefore be controlled using any known mechanism, such as a foot pedal or toggle switch. Alternatively, in some embodiments, the pump can be battery powered.

Pump 155 can include any known pump device that produces sufficient fluid flow for the volume of the system. For example, in some embodiments, the pump can be a pneumatic pump, rotary pump, or air pump. The pump can be driven by an associated control and display software. In some embodiments, a variety of pumps can be used with variations in pressures. As described below, the pump is used to simulate blood flow characteristics through the tissue sample during the simulated surgical exercise.

As shown in FIG. 7b, pump 155 further includes outlet 162 that connects to input pressure control valve 165 via tubing 160. The control valve allows a specific quantity or flow rate of fluid to pass thereby and is used to modulate actual flow rate. The pressure control valve therefore allows the user to adjust the pressure of the fluid exiting pump 155 to a desired level (e.g., to set the fluid flow to the tissue sample at a desired pressure level). Pressure control valve 165 can include any valve known or used in the art, such as (but not limited to) a solenoid valve. The control valve can be mounted to the interior of the base, as shown in FIG. 7b.

In some embodiments, tubing 160 connects input pressure control valve 165 to pressure gauge 170, as shown in FIG. 7c. The pressure of the fluid passing from the input pressure control valve can be read and displayed by the pressure gauge. In some embodiments, the pressure gauge is separately configured from the pressure valve. Alternatively, the pressure gauge can be interconnected with the pressure control valve. Any conventional pressure gauge can be used. It should be appreciated that pressure gauge 170 is optional, and fluid can be pumped from the input pressure control valve directly to the tissue sample.

From the pressure gauge, fluid is routed to the tissue sample 175 through tubing 160, as shown in FIG. 7d. As described above, working surface 30 separates the mechanics of the pumps and tubing from the tissue sample that rests on top of the tissue bed. The incoming and outgoing tubing can be hidden by penetrating through the tissue bed at the connecting point with the tissue sample. Tubing 160 is adapted to communicate with tissue 175 such that fluid flow passes into the tissue. The tubing can be mounted to the tissue in a variety of ways, such as the utilization of an artery, tissue flap, etc. The connection attachments are designed for rapid interchanging of tissue samples with minimal complication.

Tissue 175 can be any desired tissue sample, such as at least a portion of an animal organ (e.g., cow heart).

Fluid exits tissue sample 175 though tubing 160 and travels beneath the working surface to return pressure control valve 166, as shown in FIG. 7e. The return pressure valve allows a specific quantity or flow rate of fluid to pass thereby and is used to modulate actual flow rate of the fluid exiting the tissue sample. Return pressure control valve 166 therefore allows the user to adjust the pressure of the fluid exiting the tissue sample to a desired level. Return pressure control valve 166 can include any valve known or used in the art, such as (but not limited to) a solenoid valve. The control valve can be mounted to the interior of the base. Fluid is then routed from the return pressure control valve to fluid basin 130, as shown in FIG. 7e. A circulatory path for the fluid is thereby created. The rate of fluid flow to and from tissue sample 175 is balanced through regulation of the control valves 165, 166 and pump 155.

The fluid basin, pump, input and return pressure control valves, and pressure gauge are maintained primarily below working surface 30. In this way, the mechanics are kept out of sight, providing a clean look to the system and not distracting the user and/or audience during the surgical simulation procedures. In some embodiments, the pressure control valves and pressure gauge can be mounted to one or more internal faces of the base using known methods. For example, in some embodiments, adhesive, bolts, screws, clips, and the like can be used.

Optionally, the disclosed system can include heating/cooling element 180 to heat and/or cool the fluid as it is pumped through the system, as illustrated in FIG. 7f. Any conventional heating or cooling element can be used.

In some embodiments, the interior of base 25 can include one or more additional compartments. For example, the interior of the base can include an insulated or cooled replacement tissue storage compartment. In some embodiments, the interior of the base can include an expired tissue compartment that holds tissue sample 175 after a surgical simulation has been completed. Further, the interior of the base can include a tool storage compartment for housing one or more surgical tools to be used during a simulation.

In use, simulation system 5 is assembled by positioning the fluid basin within the bottom of base 25. Fluid is added to the basin in a sufficient volume to be pumped through tissue sample 175. Pump 155 is connected to the fluid basin via tubing 160 at pump inlet 156. The pump is further connected to input pressure control valve 165 at pump outlet 162. The inlet pressure control valve is connected to pressure gauge 170 via tubing 160. The pressure gauge is connected to a first input on the tissue sample. Tubing 160 connects an output from the tissue sample to return pressure control valve 166. The fluid then passes from the return pressure control valve to fluid basin 130 via tubing 160. Working surface 30 is positioned in the top portion of the base, such that the majority of the tubing and mechanical elements (e.g., pump 155, control valves 165 and 166, pressure gauge 170) are maintained below the working surface. Tissue bed 115 can be positioned over the working surface, providing a surface upon which the tissue sample can rest during the simulation. Tissue sample 175 is deposited within the depression located in the tissue sample. Tubing 160 is then joined to the tissue sample at an inlet and outlet, thereby allowing fluid to flow through the sample when the pump is initiated. Cover 10 is positioned on the base to create a closed unit with the tissue sample maintained within the cover interior. In some embodiments, the cover rests on a lip positioned at the top surface of the base. The cover can be designed to self-anchor into the base (e.g., no closures such as screws, bolts, or clips are required).

In use, pump 155 is initiated to drive fluid from fluid basin 130 through tubing 160 to the input pressure valve, the pressure gauge, the tissue sample, the return pressure control valve, and back to the fluid basin. Thus, the fluid pumps through the tissue sample and “bleeds” to create a realistic surgical simulation. Real tissue training can therefore be accomplished that reliably replicates surgical situations. For example, the simulator can safely replicate cardiac surgical simulation on a pressurized real heart and aorta that will bleed fluid inside the cover with operative ports.

In some embodiments, the system is designed such that fluid flows in a retrograde direction (e.g., the opposite direction of normal physiologic blood flow). As a result, the system simulates physiologic complications in a streamlined mechanism. For example, the disclosed system can include the flow of fluid (e.g., blood) towards the heart.

Simulation system 5 can be configured as a single user demonstration as described above. However, the disclosed system can also be configured to allow two users. Further, the disclosed system can be constructed as a multi-user unit and can be extended to contain multiple tissue samples 175 within a single cover 10.

The disclosed simulator can be used in clinical as well as non-clinical settings (e.g., executive boardrooms, offices, restaurant and hotel meeting rooms, conferences). In addition, the disclosed simulator can easily be used by various populations, such as surgeons, surgical staff, finance, or other non-industry personnel for educational, training, and/or entertainment purposes.

The simulator advantageously provides wide flexibility in timing, location, and circumstances for practice without need for extensive personal protective equipment.

Further, the disclosed simulator system can be fitted to require zero tissue setup and/or cleanup on training site. Thus, the entire setup can be done prior to transport to the training location. The base can then be opened and used, and all cleanup can be safely completed off site, post teardown and transport, after training has been completed.

The simulator provides users the ability to skip surgical access steps and address the key challenges they can face operatively. For example, users can recreate rare complications that are difficult to replicate in other environments. Accordingly, a safe environment is provided where a user can learn and practice with a flexible model that can be ready anywhere and anytime. The versatility of pressure controls from multiple sources also provides greater situational variations. For example, the simulator can replicate surgical situation (such as increased circulatory pressure) that cannot be replicated in animal labs due to physical restrictions and/or ethical considerations.

Accordingly, the disclosed simulator allows surgeons and surgical staff to have additional and ongoing education and practice in handling surgical challenges. The self-contained simulator provides a safe environment to learn, practice and explore new methods of addressing surgical challenges.

The simulation system advantageously provides protection for users and observers from exposure to living tissue and fluids in contact with tissue specimens. The only personal protective equipment needed is a pair of gloves. Additionally, the simulator is designed to meet with all regulatory guidelines on management of biomedical tissue storage and waste.

Further, the disclosed simulator allows individuals from all areas of a hospital (surgery, nursing, finance, etc.) the opportunity to perform, assist, and/or witness live cardiac and vascular surgical education and training. Thus, individuals that would normally never experience live surgical training are able to understand critical clinical factors in surgery, and the implications of decisions made.

The disclosed simulator also allows surgical personnel to test their own skills and compete with peers in an identical model with identical complications in a safe environment.

Advantageously, the simulator can offer many advantages for medical device companies, including (but not limited to) the ability to demonstrate products and train healthcare professionals in a cost-efficient and time-efficient manner. The device allows for consistency and replication of normal physiologic function, potential complications and super-physiologic conditions. The simulator further minimizes the time, expense, location and ethical concerns surrounding real tissue training and animal testing. It also provides a controlled mechanism for performing side-by-side product comparisons. The safety and portability functions in the disclosed simulator allow for real tissue training and demonstrations to be executed in settings otherwise considered to be impractical or unsafe.

What is claimed is:

1. A surgical simulation system comprising:
a base comprising an interior;
a fluid basin configured for housing a volume of fluid, positioned within the interior of the base;
a fluid pump positioned within the interior of the base, wherein a tubing connects the fluid basin to an inlet of the fluid pump;
an input pressure control valve connected via tubing to an outlet of the fluid control pump;
an optional pressure gauge connected via tubing to an outlet of the input pressure control valve;
tubing configured to connect the input pressure control valve to an input on a tissue sample;
tubing configured to connect an output on a tissue sample to a return pressure control valve;
tubing that connects the return pressure control valve to the fluid basin;
a cover comprising a plurality of sidewalls and an open bottom that rests on the base to create an enclosed space, wherein at least one sidewall comprises an access port that spans the sidewall;
a working surface for supporting a tissue sample, wherein the working surface is positioned within the interior of the base, adjacent to the cover.

2. The simulation system of claim 1, wherein the cover is at least partially constructed from one or more transparent materials.

3. The simulation system of claim 1, wherein the cover comprises a light source, camera, or both.

4. The simulation system of claim 1, wherein the base has a bottom surface comprising a plurality of wheels, collapsible legs, or both.

5. The simulation system of claim 1, wherein the working surface is configured at an angle within the interior of the base.

6. The simulation system of claim 5, wherein the angle is about 1-10 degrees.

7. The simulation system of claim 1, wherein a covering is positioned over the working surface, adjacent to the cover.

8. The simulation system of claim 7, wherein the covering includes a central depression sized and shaped to allow a tissue sample to rest thereon.

9. The simulation system of claim 7, wherein the covering comprises one or more apertures sized and shaped to allow tubing to pass therethrough.

10. The simulation system of claim 1, wherein the input pressure control device, return pressure control device, or both comprise a solenoid valve.

11. The simulation system of claim 1, wherein the base comprises one or more compartments housed within the interior, configured for containing cleaning supplies, surgical tools, used tissue samples, and combinations thereof.

12. The simulation system of claim 1, further comprising a heating element, cooling element or both, configured to heat or cool the fluid as it is pumped through the system.

13. A method of performing a surgery simulation on a tissue sample, the method comprising:
depositing the tissue sample on the working surface of a surgery simulation system, the simulation system comprising:
a base comprising an interior;
a fluid basin configured for housing a volume of fluid, positioned within the interior of the base;
a fluid pump positioned within the interior of the base, wherein a tubing connects the fluid basin to an inlet of the fluid pump;
an input pressure control valve connected via tubing to an outlet of the fluid control pump;
an optional pressure gauge connected via tubing to an outlet of the input pressure control valve;
tubing configured to connect the input pressure control valve to an input on a tissue sample;
tubing configured to connect an output on a tissue sample to a return pressure control valve;
tubing that connects the return pressure control valve to the fluid basin;
a cover comprising a plurality of sidewalls and an open bottom that rests on the base to create an enclosed space, wherein at least one sidewall comprises an access port that spans the sidewall;
a working surface for supporting a tissue sample, wherein the working surface is positioned within the interior of the base, adjacent to the cover depositing a volume of fluid in the fluid basin;
initiating the pump to begin pumping the fluid from the fluid basin, through the pump, through the input pressure control valve, through the optional pressure gauge, through the tissue sample, through the return pressure control valve, and back to the fluid basin; and
performing the surgery simulation by accessing the tissue sample through the access ports of the cover.

14. The method of claim 13, wherein the system further comprises a heating element, cooling element, or both, such that fluid passes through the elements to be heated or cooled as desired by the user.

15. The method of claim 13, wherein the cover is at least partially constructed from one or more transparent materials.

16. The method of claim 13, wherein the base has a bottom surface comprising a plurality of wheels, collapsible legs, or both.

17. The method of claim 13, wherein the working surface is configured at an angle within the interior of the base.

18. The method of claim 13, wherein a covering is positioned over the working surface, adjacent to the cover.

19. The method of claim 18, wherein the covering includes a central depression sized and shaped to allow a tissue sample to rest thereon.

20. The method of claim 18, wherein the covering comprises one or more apertures sized and shaped to allow tubing to pass therethrough.
